(19) United States
(12) Patent Application Publication
(10) Pub. No.: US 2024/0203264 A1
(43) Pub. Date: Jun. 20, 2024

(54) METHODS AND INTERNET OF THINGS SYSTEMS FOR MANAGING GARBAGE TREATMENT DEVICE IN SMART CITIES

(71) Applicant: CHENGDU QINCHUAN IOT TECHNOLOGY CO., LTD., Chengdu (CN)

(72) Inventors: Zehua SHAO, Chengdu (CN); Bin LIU, Chengdu (CN); Yaqiang QUAN, Chengdu (CN); Yong LI, Chengdu (CN); Xiaojun WEI, Chengdu (CN)

(73) Assignee: CHENGDU QINCHUAN IOT TECHNOLOGY CO., LTD., Chengdu (CN)

(21) Appl. No.: 18/153,331

(22) Filed: Jan. 11, 2023

(30) Foreign Application Priority Data
Dec. 15, 2022 (CN) 202211616061.1

(51) Int. Cl. G08G 1/00; G06Q 10/0631; G06Q 10/30

(52) U.S. Cl. CPC G08G 1/207; G06Q 10/06315; G06Q 10/30; G16Y 10/35

(57) ABSTRACT

The embodiments of the present disclosure provide methods and Internet of Things (IoT) systems for managing a garbage treatment device in a smart city. The method may be executed based on a management platform of the IoT system for managing the garbage treatment device in the smart city. The method may include: obtaining a garbage accumulation condition in a target area; determining at least one sub-area in the target area as at least one garbage point to be treated based on the garbage accumulation condition; and determining, based on the at least one garbage point to be treated, a garbage truck dispatching plan of the target area. The garbage truck dispatching plan may include: a type of at least one garbage truck to be dispatched, and a departure time of the at least one garbage truck.

### CROSS-REFERENCE TO RELATED APPLICATION

This application claims priority of Chinese Patent Application No. 202211616061.1, filed on Dec. 15, 2022, the contents of which are entirely incorporated herein by reference.

### TECHNICAL FIELD

The present disclosure relates to a field of intelligent management of a garbage treatment device, and in particular, to methods and Internet of Things systems for managing a garbage treatment device in a smart city.

### BACKGROUND

With an influx of people into a city, more and more garbage is generated in the city, and there are often too many garbage at garbage points in communities and streets, which will not only affect an appearance of the city, but also breed bacteria and affect people's health if the garbage is stacked for too long.

Therefore, it is hoped to provide a method and an Internet of Things system for managing a garbage treatment device in a smart city, which can be used to determine a garbage truck dispatching plan based on a garbage stacking situation in the target area, so as to dispatch garbage trucks in a timely and flexible manner, thereby realizing timely cleaning of the garbage points in the various urban areas, and further saving management costs.

### SUMMARY

One of the embodiments of the present disclosure provides a method for managing a garbage treatment device in a smart city, which is executed based on a management platform of an Internet of Things (IoT) system for managing the garbage treatment device in the smart city. The method may include: obtaining a garbage accumulation condition in a target area; determining, based on the garbage accumulation condition, at least one sub-area in the target area as at least one garbage point to be treated; and determining, based on the at least one garbage point to be treated, a garbage truck dispatching plan of the target area. The garbage truck dispatching plan may include: a type of at least one garbage truck to be dispatched, and a departure time of the at least one garbage truck.

One of the embodiments of the present disclosure provides an IoT system for managing a garbage treatment device in a smart city including a user platform, a service platform, a sensor network platform, and an object platform. The object platform may be configured to obtain the garbage accumulation condition in a target area. The sensor network platform may be configured to transmit the garbage accumulation condition in the target area obtained by the object platform to the management platform. The management platform may be configured to: determine, based on the garbage accumulation condition, at least one sub-area in the target area as at least one garbage point to be treated; and determine, based on the at least one garbage point to be treated, a garbage truck dispatching plan of the target area, wherein the garbage truck dispatching plan includes: a type of at least one garbage truck to be dispatched, and a departure time of the at least one garbage truck. The service platform may be configured to feed back the garbage truck dispatching plan to a user through the user platform.

One of the embodiments of the present disclosure provides a non-transitory computer-readable storage medium storing computer instructions. When reading the computer instructions in the storage medium, a computer may implement the method for managing a garbage treatment device in a smart city.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, wherein:

FIG. 1 is a schematic diagram illustrating an exemplary Internet of Things (IoT) system for managing a garbage treatment device in a smart city according to some embodiments of the present disclosure;

FIG. 2 is a flowchart illustrating an exemplary process of a method for managing a garbage treatment device in a smart city according to some embodiments of the present disclosure;

FIG. 3 is a flowchart illustrating an exemplary process for determining at least one garbage point to be treated according to some embodiments of the present disclosure;

FIG. 4 is a flowchart illustrating an exemplary process for determining a garbage truck dispatching plan of a target area according to some embodiments of the present disclosure; and

FIG. 5 is a flowchart illustrating another exemplary process for determining a garbage truck dispatching plan in a target area according to some embodiments of the present disclosure.

### DETAILED DESCRIPTION

In order to more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that the “system,” “device,” “unit,” and/or “module” used herein are one method to distinguish different components, elements, parts, sections, or assemblies of different levels. However, if other words can achieve the same purpose, the words can be replaced by other expressions.

As used in the disclosure and the appended claims, the singular forms “a,” “an,” and “the” include plural referents unless the content clearly dictates otherwise; the plural forms may be intended to include singular forms as well. In general, the terms “comprise,” “comprises,” and/or “comprising,” “include,” “includes,” and/or “including,” merely prompt to include steps and elements that have been clearly identified, and these steps and elements do not constitute an exclusive listing. The methods or devices may also include other steps or elements.

The flowcharts used in the present disclosure illustrate operations that the system implements according to the embodiment of the present disclosure. It should be understood that the foregoing or following operations may not necessarily be performed exactly in order. Instead, the operations may be processed in reverse order or simultaneously. Besides, one or more other operations may be added to these processes, or one or more operations may be removed from these processes.

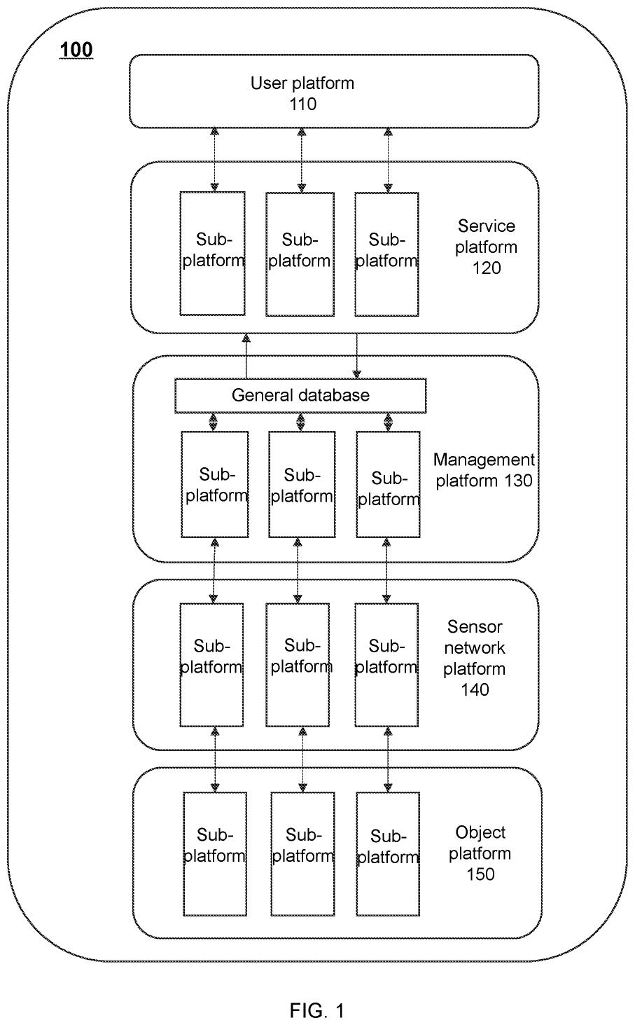

FIG. 1 is a schematic diagram illustrating an exemplary Internet of Things (IoT) system for managing a garbage treatment device in a smart city according to some embodiments of the present disclosure.

As shown in FIG. 1, the IoT system 100 for managing a garbage treatment device in a smart city may include a user platform 110, a service platform 120, a management platform 130, a sensor network platform 140, and an object platform 150.

The user platform 110 may be a user-oriented platform for obtaining a user need and feeding back information to the user. In some embodiments, the user platform 110 may be configured as a terminal device. For example, the terminal device may include an intelligent electronic device that realizes data processing and data communication such as a desktop computer, a tablet computer, a notebook computer, a mobile phone, etc.

In some embodiments, the user platform 110 may be configured to receive a garbage truck dispatching plan (e.g., a type of a garbage truck, a departure time of the garbage truck, etc.) of each area of the city sent by the service platform 120, and send a garbage truck dispatching plan query instruction of each area of the city to the service platform 120.

The service platform 120 may be a platform for receiving and transmitting data and/or information. For example, the service platform 120 may be configured to receive the garbage truck dispatching plan of each area of the city uploaded by a general database of the management platform 130, and send the garbage truck dispatching plan of each area of the city to the user platform 110. In some embodiments, the service platform 120 may further be configured to receive the garbage truck dispatching plan query instruction of each area of the city issued by the user platform 110, and transmit the garbage truck dispatching plan query instruction to the general database of the management platform 130.

In some embodiments, the service platform 120 may include a plurality of service sub-platforms. The service sub-platforms may be in one-to-one correspondence with management sub-platforms. The service sub-platforms may be divided based on the area of the city (e.g., an area A, an area B, etc.).

The management platform 130 may refer to a platform for overall planning and coordinating connections and cooperation among various functional platforms, gathering all information of the IoT system, and providing perceptual management and control management functions for the IoT operation system. For example, the management platform 130 may be configured to receive garbage monitoring-related data (e.g., a garbage accumulation condition, etc.) in the each area of the city uploaded by the sensor network platform 140, and then process the above-mentioned garbage monitoring-related data to determine the garbage truck dispatching plan of each area of the city.

In some embodiments, the management platform 130 may include a general database and a plurality of management sub-platforms. The plurality of management sub-platforms may be in one-to-one correspondence with sensor network sub-platforms. The management sub-platforms may be divided based on the areas of the city.

In some embodiments, the management sub-platform may be configured to receive the garbage monitoring-related data in each area of the city uploaded by the sensor network sub-platform, process the garbage monitoring-related data, and then send the garbage monitoring-related data to the general database for aggregation and storage after the processing of the management sub-platform is completed. The general database may send the garbage monitoring-related data to the service sub-platform corresponding to each area, and transmit the garbage monitoring-related data to the user platform 110 through each service sub-platform. In some embodiments, the general database may be configured to receive the garbage truck dispatching plan query instruction of each area of the city issued by the service sub-platform, and send the query instruction to the corresponding management sub-platforms. After receiving the above-mentioned the garbage truck dispatching plan query instruction, the management sub-platform may generate a corresponding garbage monitoring-related data query instruction and send the query instruction to the corresponding sensor network sub-platform.

The sensor network platform 140 may refer to a platform that processes, stores, and transmits data and/or information. For example, the sensor network platform 140 may be configured to receive the garbage monitoring-related data in each area of the city obtained by the object platform 150 and upload the data to the management platform 130. In some embodiments, the sensor network platform 140 may be configured as a communication network and a gateway.

In some embodiments, the sensor network platform 140 may include a plurality of sensor network sub-platforms that are in one-to-one correspondence with object sub-platforms. The sensor network sub-platforms may be divided based on the areas of the city. In some embodiments, each sensor network sub-platform may be configured with an independent gateway.

In some embodiments, the sensor network sub-platform may be configured to receive the garbage monitoring-related data in each area of the city uploaded by the object sub-platform, and transmit the data to the corresponding management sub-platform. The sensor network sub-platform may further be configured to receive the above-mentioned the garbage monitoring-related data query instruction issued by the management sub-platform, and send the query instruction to the corresponding object sub-platform.

The object platform 150 may be a functional platform for obtaining data and/or information. For example, the object platform may be configured to obtain the garbage monitoring-related data in each area of the city, and transmit the data to the management platform 130 through the sensor network platform 140. In some embodiments, the object platform 150 may be configured as a monitoring device (e.g., a camera device, etc.), which may be deployed in a community in each area of the city.

In some embodiments, the object platform 150 may include a plurality of object sub-platforms, and each object sub-platform may further be divided based on the areas of the city. In some embodiments, the object sub-platform may be configured to receive the garbage monitoring-related data query instructions in each area of the city issued by the sensor network sub-platform. After obtaining the corresponding garbage monitoring-related data, the data may be uploaded to the corresponding management sub-platform through the corresponding sensor network sub-platform.

In some embodiments of the present disclosure, the IoT system for managing a garbage treatment device in a smart city may be constructed based on five platform structures. A structural design based on each platform may ensure independence between different types of data, classified transmission, traceability of the data, and a classified issuance and process of the instructions, so that structure and data processing of the IoT may be clear and controllable, thereby facilitating management, control, and data processing of the IoT.

It should be noted that the above description of the IoT system for managing a garbage treatment device in a smart city and the modules thereof is merely for convenience of illustration and not intended to limit the present disclosure to the scope of the illustrated embodiments. It can be understood that for those skilled in the art, after understanding the principle of the system, various modules may be combined arbitrarily, or a sub-system may be formed to connect with other modules without departing from the principle. In some embodiments, the user platform, the service platform, the management platform, the sensor network platform, and the object platform disclosed in FIG. 1 may be different modules in a system, or a module implementing the functions of the two or more modules. For example, each module may share one storage module, and each module may also have its own storage module. Such variations are all within the protection scope of the present disclosure.

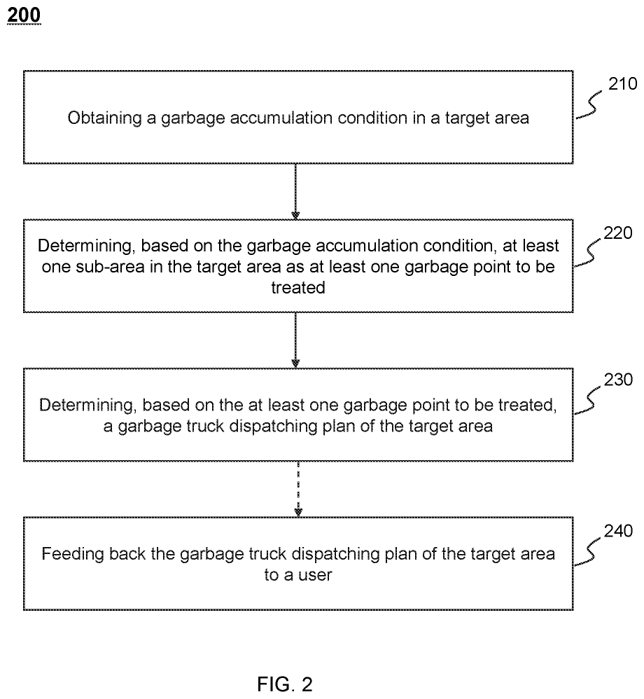

FIG. 2 is a flowchart illustrating an exemplary process of a method for managing a garbage treatment device in a smart city according to some embodiments of the present disclosure.

In some embodiments, the process 200 may be performed by the management platform 130. As shown in FIG. 2, the process 200 may include the following operations.

In 210, obtaining a garbage accumulation condition in a target area.

The target area may refer to any area within a city. For example, the target area may be a certain community, a certain street, etc. in the city. As another example, if a city has 3 areas, namely an area A, an area B, and an area C, these three areas may all be considered as the target areas.

The target area may be determined based on various modes, such as a random determination mode, etc. In some embodiments, the target area may be determined based on a preset rule, for example, each area may be selected as the target area one by one in an alphabetical order (a, b, c . . . ) based on an initial letter of a name of each area in the city. The preset rule may be a rule set in advance, which may be determined based on various modes such as historical experience, an algorithm, etc.

The garbage accumulation condition may refer to an accumulation volume of garbage. In some embodiments, a management sub-platform may obtain the garbage accumulation condition in each area of the city based on an object sub-platform. The object sub-platform may be configured as a monitoring device (such as a camera device, etc.) of the community of each area of the city, and may be configured to obtain the garbage accumulation condition in each area of the city.

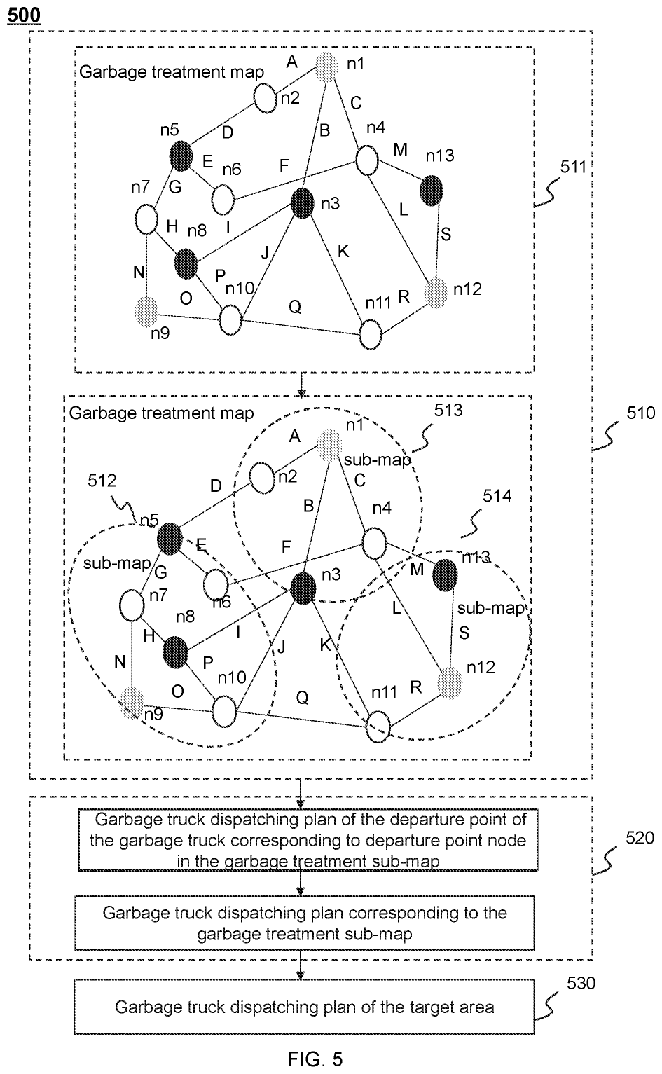

In some embodiments, the garbage accumulation condition may further include a historical garbage volume of each sub-area in the target area at a plurality of historical moments. In some embodiments, the target area may be further divided into a plurality of sub-areas, and each sub-area may include one or more garbage points, garbage bins, etc. for collecting garbage. For further description regarding dividing the sub-areas, please refer to FIG. 5 and the related description thereof.

The plurality of historical moments may refer to a plurality of moments before current moment. The historical garbage volume may refer to the corresponding garbage accumulation volume at the plurality of historical moments.

In 220, determining, based on the garbage accumulation condition, at least one sub-area in the target area as at least one garbage point to be treated.

The garbage point to be treated may refer to a sub-area that needs to be performed with a garbage treatment.

There may be a plurality of ways to determine the garbage point to be treated. In some embodiments, a sub-area where the garbage accumulation volume exceeds an accumulation threshold may be determined as the garbage point to be treated based on the garbage accumulation condition. For example, for a sub-area A1 in the area A, if a set accumulation threshold is 2 m³, but an actual garbage accumulation volume in the sub-area A1 is 2.5 m³, the sub-area A1 may be regarded as a garbage point to be treated. The accumulation threshold may be a preset value, which may be determined based on an actual condition.

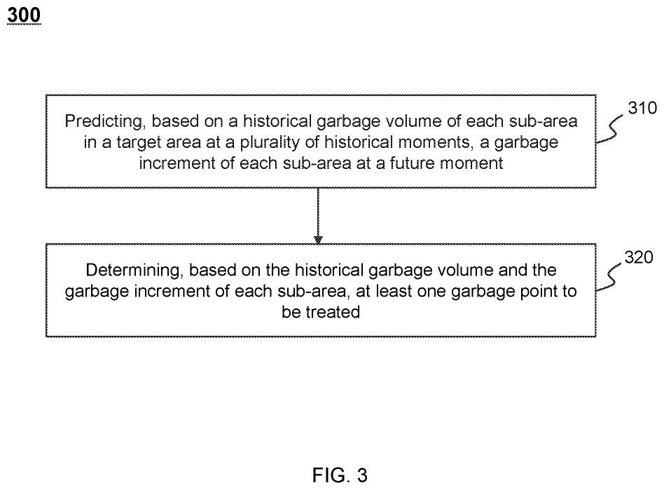

In some embodiments, it may further predict, based on the historical garbage volume of each sub-area in the target area at a plurality of historical moments, a garbage increment of each sub-area at a future moment, and then determine, based on the historical garbage volume and the garbage increment of each sub-area, the at least one garbage point to be treated. The historical garbage volume may refer to an accumulation volume of garbage at a previous moment. For specific description regarding how to predict the garbage increment based on the historical garbage volume of each sub-area, and then determine the garbage point to be treated based on the historical garbage volume and the garbage increment, please refer to FIG. 3 and related description thereof.

In 230, determining, based on the at least one garbage point to be treated, a garbage truck dispatching plan of the target area.

The garbage truck dispatching plan may refer to a relevant plan of dispatching the garbage truck, including but not limited to a garbage truck route, a departure period of the garbage truck, etc. For example, when it is found that the garbage increment of at least one garbage point to be treated suddenly increases, the garbage truck dispatching plan may be a new plan obtained by changing the garbage truck route on the basis of an original plan, shortening a departure time of the garbage truck of the garbage point to be treated where the garbage increment increases, etc. The garbage increment may refer to an increase volume of the garbage in a period of time, which may be used to reflect garbage growth.

In some embodiments, the garbage truck dispatching plan may include: a type of at least one garbage truck to be dispatched, and the departure time of the at least one garbage truck.

In some embodiments, the type of the garbage truck may be classified according to a capacity of a garbage truck. For example, when 1 m³<the capacity of the garbage truck≤3 m³, the type of the garbage truck may be a small garbage truck; when 3 m³<the capacity of the garbage truck≤5 m³, the type of garbage truck may be a medium garbage truck; when the capacity of the garbage truck>5 m³, the type of garbage truck may be a large garbage truck. The type of garbage truck may further be classified in other ways, such as based on a function of the garbage truck, which is not limited in the present disclosure.

The departure time of the garbage truck may refer to a time when the garbage truck departs from an initial station. The departure time of the garbage truck may be determined in various ways, such as based on historical experience, etc.

In some embodiments, the departure time of the garbage truck may be determined based on the garbage accumulation condition of the garbage point to be treated, which may be related to the garbage accumulation condition of the garbage point to be treated. For example, the greater the garbage accumulation volume at the garbage point to be treated is or the greater the growth rate of the garbage increment at the garbage point to be treated is, the earlier the departure time of the garbage truck. Specifically, when it is found that the growth rate of the garbage increment of at least one garbage point to be treated exceeds a growth rate threshold, the departure time of the garbage truck may be set earlier. The growth rate threshold may be determined based on historical experience, etc.

In some embodiments, the management platform 130 may determine the garbage truck dispatching plan in various ways. For example, the management sub-platform of the management platform 130 may match the garbage monitoring-related data (e.g., the garbage accumulation condition, etc.) of the target area with historical garbage monitoring-related data, use most similar historical garbage monitoring-related data as reference data, and use a historical reference garbage truck dispatching plan corresponding to the reference data as the garbage truck dispatching plan of the target area. The historical garbage monitoring-related data may refer to a collection of the historical garbage monitoring-related data in various areas of the city. The reference data may refer to data that is most similar to the garbage monitoring-related data in the target area in the historical data. The historical reference garbage truck dispatching plan may refer to a garbage truck dispatching plan adopted when the target area is in a state of the reference data.

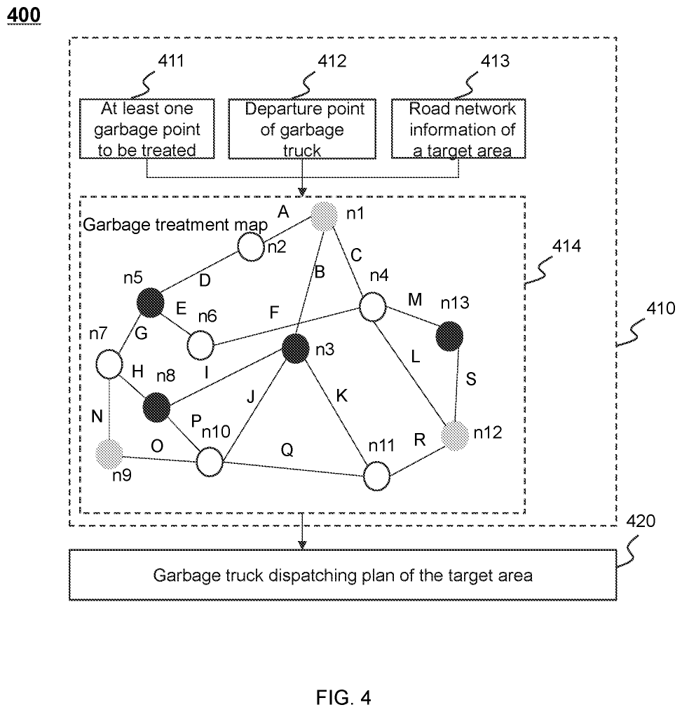

In some embodiments, a garbage treatment map corresponding to the target area may be constructed based on the at least one garbage point to be treated, the departure time of the garbage truck, and road network information of the target area, and then the garbage truck dispatching plan of the target area may be determined based on the garbage treatment map. For description regarding how to construct the garbage treatment map corresponding to the target area, and how to determine the garbage truck dispatching plan of the target area based on the garbage treatment map, please refer to FIG. 4 and related description thereof.

In some embodiments, at least one garbage treatment sub-map may be further determined based on the garbage treatment map. Each of the at least one garbage treatment sub-map may include at least one departure point node. A garbage truck dispatching plan of the departure point of the garbage truck corresponding to the departure point node in the garbage treatment sub-map may be determined based on the garbage treatment sub-map. Then, a garbage truck dispatching plan corresponding to the garbage treatment sub-map may be determined. Finally, the garbage truck dispatching plan of the target area may be determined based on the garbage truck dispatching plan corresponding to each of the garbage treatment sub-maps. For specific description regarding how to determine the at least one garbage treatment sub-map based on the garbage treatment map, then determine the garbage truck dispatching plan corresponding to the garbage treatment sub-map, and finally determine the garbage truck dispatching plan of the target area, please refer to FIG. 5 and related description thereof.

In some embodiments, the process 200 may further include the following operation.

In 240, feeding back the garbage truck dispatching plan of the target area to a user.

In some embodiments, after determining the garbage truck dispatching plan of the target area, the management sub-platform of the management platform 130 may transmit the above-mentioned garbage truck dispatching plan to the corresponding service sub-platform through the general database. The service sub-platform may then send the above-mentioned garbage truck dispatching plan to the user platform 110. The user may obtain the garbage truck dispatching plan of the target area from the user platform 110.

In some embodiments of the present disclosure, the determination and transmission of the garbage truck dispatching plan of the target area may be realized based on the IoT system for managing a garbage treatment device in a smart city, which may facilitate timely and flexible dispatching of the garbage trucks according to the garbage accumulation condition in the target area, thereby ensuring cleanliness of the city and reducing management costs at the same time.

FIG. 3 is a flowchart illustrating an exemplary process for determining at least one garbage point to be treated according to some embodiments of the present disclosure.

In some embodiments, the process 300 may be performed by management platform 130. As shown in FIG. 3, the process 300 may include the following operations.

In 310, predicting, based on a historical garbage volume of each sub-area in a target area at a plurality of historical moments, a garbage increment of each of sub-area at a future moment.

The garbage increment may refer to an increased garbage volume of a garbage amount at a certain moment relative to a garbage volume at a previous moment of a certain sub-area in the target area. For example, if a garbage volume at a certain moment t₁ is V₁, and a garbage volume at the next moment t₂ is V₂, then the garbage increment ΔV=V₂−V₁. In some embodiments, the garbage increment may be an increment of the garbage volume of a garbage amount at a future moment (e.g., 1 hour in the future) relative to a garbage volume at a current moment of each sub-area in the target area.

In some embodiments, the management platform 130 may determine, based on the historical garbage volume of each sub-area in the target area at the plurality of historical moments, the garbage increment of each of sub-area at the future moment. For relative description regarding the historical garbage volume, please refer to FIG. 2 and related description thereof.

In some embodiments, the management platform 130 may predict, based on a prediction model, the garbage increment of each sub-area in the target area at the future moment.

The prediction model may refer to a model used to predict the garbage increment. In some embodiments, the prediction model may be a trained machine learning model. For example, the prediction model may include a deep neural networks (DNN) model, a recurrent neural networks (RNN) model, a long short-term memory (LSTM) model, other custom model structures, or any combination thereof.

In some embodiments, an input of the prediction model may include the garbage volume at the plurality of historical moments and one or more future moments. The prediction model may process the garbage volume at the plurality of historical moments and the one or more future moments, and output the garbage increment at the one or more future moments.

It should be noted that the plurality of historical moments and the one or more future moments may be a continuous time sequence based on a preset time step. For example, 2 hours may be preset as a time step, and a time point may be obtained every 2 hours. Accordingly, the garbage volume at the plurality of historical moments may be determined based on garbage volume corresponding to each historical time point. The plurality of historical moments may include the current moment, and the garbage volume at the plurality of historical moments may further include garbage volume at the current moment.

In some embodiments, the prediction model may be obtained by training garbage volume at a plurality of sample historical moments with labels and one or more sample future moments. The garbage volume of the plurality of sample historical moments may be historical garbage volume data of a past day or a past week. For example, garbage volume at 0:00, 2:00, 4:00 . . . 16:00 of the past day may be taken as garbage volume of a group of sample historical moments. Accordingly, the one or more moments of 18:00, 20:00, 22:00, etc. of the past day may be taken as the one or more sample future moments corresponding to the plurality of sample historical moments. The label may be a garbage increment corresponding to the one or more sample future moments (e.g., one or more moments of the aforementioned 18:00, 20:00, and 22:00). The label may be manually annotated, etc.

When training an initial prediction model, the management platform 130 may input each group of sample historical garbage volumes into the initial prediction model to output the garbage increment at the plurality of future moments. The management platform 130 may construct a loss function based on the label of each group of sample historical garbage volumes and the output of the initial prediction model, and iteratively update parameters of the initial prediction model based on the loss function until a preset condition is satisfied, complete the training, and obtain a trained prediction model. The preset condition may be that the loss function is smaller than a threshold, the loss function converges, or a training period reaches a threshold.

In some embodiments, the management platform 130 may further predict, based on the historical garbage volume of each sub-area in the target area at a plurality of historical moments and a historical pedestrian volume sequence, the garbage increment of each of sub-area in the target area at the future moment.

The historical pedestrian volume sequence may refer to a pedestrian volume at a plurality of consecutive historical moments based on a preset time step. For example, the historical pedestrian volume sequence may be a pedestrian volume sequence formed by the pedestrian volume at 0:00, 2:00, 4:00, 16:00 of the past day based on a time step of 2 hours. In some embodiments, the management platform 130 may determine the historical pedestrian volume sequence based on historical pedestrian volume data of each sub-area in the target area.

In some embodiments, the input of the prediction model may further include a historical pedestrian volume sequence. The prediction model may process the garbage volume at the plurality of historical moments, the historical pedestrian volume sequence, and the one or more future moments, and output the garbage increment of the one or more future moments.

In some embodiments, when training the initial prediction model, a first training sample of the prediction model may include the garbage volume at the plurality of sample historical moments, the one or more sample future moments, and a sample historical pedestrian volume sequence. The garbage volume at the plurality of sample historical moments and the sample historical pedestrian volume sequence may correspond to a same time sequence. A first label may be a garbage increment corresponding to the one or more sample future moments of the group. The management platform 130 may input the garbage volume at the plurality of sample historical moments, the one or more sample future moments, and the sample historical pedestrian volume sequence into the prediction model to output the garbage increment at the one or more future moments. For the training of the prediction model, please refer to the previous description of the prediction model, which will not be repeated here.

In some embodiments of the present disclosure, the prediction model can quickly and efficiently determine the garbage increment at the plurality of future moments, and at the same time, an introduction of the historical pedestrian volume sequence can help to make a determined result of the garbage increment at the plurality of future moments more accurate.

In 320, determining, based on the historical garbage volume and the garbage increment of each of sub-area, at least one garbage point to be treated.

In some embodiments, the management platform 130 may determine, based on the historical garbage volume and the garbage increment of each sub-area, a garbage accumulation volume of the current and/or future moment of each sub-area, and determine a sub-area where the garbage accumulation volume exceeds an accumulation threshold as the garbage point to be treated. For the specific description regarding the garbage point to be treated, please refer to FIG. 2 and related description thereof.

In some embodiments, the management platform 130 may determine, based on the historical garbage volume and the garbage increment of each of sub-area, a treatment demand degree of each of sub-area, and determine, based on the treatment demand degree of each of sub-area, the at least one garbage point to be treated.

The treatment demand degree may refer to a degree of demand for garbage cleaning in a sub-area. The treatment demand degree may be expressed as a numerical value, such as 5, 8.5, etc. The larger the value is, the higher the treatment demand degree of the sub-area is, and the more garbage cleaning is required for the sub-area. The treatment demand degree may be determined based on a preset algorithm or formula. Exemplarily, the treatment demand degree may be determined based on the following equation (1):

F=k₁*V₁+k₂*V₂ (1)

where F in equation (1) denotes the treatment demand degree; V₁ denotes the current garbage volume in the target sub-area; V₂ denotes the garbage increment of the target sub-area at the future moment (e.g., 1 hour, 2 hours in the future); k₁ and k₂ are preset weight coefficients, which may be preset values, for example, k₁=0.6, and k₂=0.4.

In some embodiments, the management platform 130 may determine the sub-area whose treatment demand degree is higher than a preset demand degree threshold as the garbage point to be treated. The preset demand degree threshold may be determined based on various modes such as experience, etc., which is not limited here. For example, the preset demand degree threshold may be 5, 10, etc.

In some embodiments of the present disclosure, determining the garbage point to be treated by the treatment demand degree can help to make it more in line with an actual situation when determining whether the garbage cleaning is required in the target sub-area.

In some embodiments, the treatment demand threshold may be related to an average value of sub-map load values of a plurality of sub-maps after the sub-maps are divided. Each sub-map may include at least one garbage point to be treated. When a sub-map load value is larger, it indicates that a road condition in an area corresponding to the sub-map is more complicated and a count of the garbage points to be treated is greater. It may be understood that the greater the sub-map load value of each of the plurality of sub-maps is, the greater the average value of the sub-map load values of the plurality of sub-maps is, and the greater the workload or the pressure of the garbage truck in a garbage cleaning is. For further description regarding the sub-maps and the sub-map load, please refer to FIG. 4 and the related description thereof.

In some embodiments, the management platform 130 may reduce a count of garbage points to be treated corresponding to each sub-map by increasing the treatment demand degree threshold when the average value of the sub-map load values is relatively large. For example, when the average value of the sub-map load values of a plurality of current garbage treatment sub-maps is relatively large, a current treatment demand threshold may be increased (for example, gradually increased to 8, 9, 10, etc.) for a plurality of times to gradually reduce the count of garbage points to be treated in each garbage treatment sub-map, thereby gradually reducing the sub-map load value of each garbage treatment sub-map. When the average value of the sub-map load values of all garbage treatment sub-maps is reduced to a preset load average value threshold, the treatment demand degree threshold may be stopped increasing. At this time, the sub-map load of each garbage treatment sub-map of the plurality of the garbage treatment sub-maps may reach an expected value.

In some embodiments of the present disclosure, when the sub-maps are divided, combining the treatment demand degree threshold and the average value of the sub-map load values of each garbage treatment sub-map may help to balance the sub-map load values of the plurality of garbage treatment sub-maps after division. In this way, the count of garbage points to be treated of each garbage treatment sub-map may be more effectively adjusted, thereby reducing a garbage cleaning pressure of a subsequent garbage truck, and improving a degree of humanization.

In some embodiments of the present disclosure, the garbage point to be treated may be determined by predicting the garbage increment of each sub-area at the future moment, which can improve efficiency of determining the garbage point to be treated, and reduce labor and material costs brought by manual observation.

FIG. 4 is a flowchart illustrating an exemplary process for determining a garbage truck dispatching plan of a target area according to some embodiments of the present disclosure.

In some embodiments, the process 400 may be performed by the management platform 130. As shown in FIG. 4, the process 400 may include the following operations.

In 410, constructing, based on at least one garbage point to be treated, a departure point of the garbage truck, and road network information of the target area, a garbage treatment map corresponding to the target area.

The garbage treatment map may refer to a knowledge map of distribution of the garbage points to be treated in the target area, which may be used to indicate information such as a count of garbage points to be treated in the target area, a distance between the garbage points to be treated, etc. In some embodiments, the management platform 130 may construct, based on the at least one garbage point to be treated, the departure point of the garbage truck, and the road network information of the target area, the garbage treatment map corresponding to the target area.

As shown in FIG. 4, the management platform 130 may construct a garbage treatment map 414 based on at least one garbage point to be treated 411, a departure point of the garbage truck 412 and road network information of the target area 413.

The garbage treatment map 414 may include a plurality of nodes. In some embodiments, the node of the garbage treatment map 414 may include a garbage truck departure point node and an intersection node.

The departure point node may be used to indicate the departure point of garbage truck in the target area. The departure point node may be determined based on information such as a count, a location, etc. of the departure point. In some embodiments, the management platform 130 may determine the departure point node based on the departure point of the garbage truck 412. The departure point node in the garbage treatment map 414 may include: a node n1, a node n9, and a node n12 (e.g., a gray solid node).

A feature of the departure point node may include whether the node is a garbage point to be treated, a historical garbage volume, and a garbage increment at a future moment. The feature of the departure point node may further include other information such as a type, a capacity, and a count of the garbage trucks, and location information of the departure point of the garbage truck, etc.

The intersection node may be used to indicate a street intersection in the target area. The intersection node may be determined based on the road network information. In some embodiments, the management platform 130 may determine the intersection nodes based on the road network information 413. The intersection node in the garbage treatment map 414 may include: a node n2, a node n4, a node n6, etc. (e.g., a white hollow node).

A feature of the intersection node may include whether the node is a garbage point to be treated, the historical garbage volume, and the garbage increment at the future moment. The feature of the intersection nodes may further include other information such as an intersection location, a name, a current traffic flow at the intersection, whether the intersection is congested, etc.

The garbage treatment map 414 may include a plurality of edges. The edge of the garbage treatment map 414 may be used to indicate a passable street in the road network, which may be determined based on actual street information in the road network. In some embodiments, the management platform 130 may determine the plurality of edges of the garbage treatment map 414 based on the road network information 413. The edge in the garbage treatment map 414 may include: an edge A, an edge B, an edge C, etc.

A feature of the edge in the garbage treatment map 414 may include whether the edge is a garbage point to be treated, the historical garbage volume, and the garbage increment at the future moment. The feature of the edge in the garbage treatment map 414 may further include other information such as a length (e.g., L=100 m), a width (e.g., W=3 m), etc. It should be noted that the street corresponding to the edge of the garbage treatment map 414 may include a plurality of garbage accumulation areas (e.g., a public garbage bin, etc.), when a current garbage volume in the street (e.g., a total garbage volume in the plurality of garbage accumulation areas, etc.) reaches a preset condition of the garbage point to be treated (for example, when the current garbage volume reaches an accumulation threshold), the street may become the garbage point to be treated. Accordingly, the edge corresponding to the street may be set as a garbage point to be treated node, and a feature value of whether the edge is a garbage point to be treated may be set to 1.

In some embodiments, for features of some of the nodes or the edges, when the feature value of whether the node/edge is the garbage point to be treated is set to 1, the edge or the node may be correspondingly set as a garbage point to be treated node, such as the node n3, the node n5, the node n8, the node n13 in the garbage treatment map. The garbage point to be treated node may be used to indicate the at least one garbage point to be treated in the target area. The garbage point to be treated node may be determined based on information such as a count, locations, etc. of the garbage points to be treated in the target area.

The management platform 130 may dynamically adjust the garbage point to be treated node based on the feature of each node and edge in the garbage treatment map 414. An adjustment mode may be determined according to the current garbage volume of each node and edge and the garbage increment at the future moment. Exemplarily, when the current garbage volume of a certain node does not meet a condition of the garbage point to be treated (for example, the current garbage volume is smaller than the accumulation threshold), the node may not be a garbage point to be treated node. When the garbage volume at the node at the future moment meets the condition of the garbage point to be treated, and the current time reaches the aforementioned future moment, the node may be adjusted to become the garbage point to be treated node. At this time, the management platform 130 may adjust the node feature value of whether the node is a garbage point to be treated to 1.

The feature of the garbage point to be treated node may include various information. For example, the feature of the garbage point to be treated node may include garbage volume information, such as the current garbage volume and the garbage increment at the future moment. As another example, the feature of the garbage point to be treated node may further include area information, such as information of an area to which the garbage point to be treated belongs, location information, etc. It should be noted that when the current garbage volume of a garbage point to be treated is reduced smaller the accumulation threshold, the garbage point to be treated may be adjusted to a non garbage point to be treated. The non garbage point to be treated may correspond to the intersection node or the edge in the garbage treatment map 414. Similarly, if the current garbage volume of a certain intersection node or a certain edge in the garbage treatment map 414 exceeds the accumulation threshold, the node or edge may need to be adjusted to a garbage point to be treated node.

It should be noted that, when a certain edge in the garbage treatment map 414 is adjusted to a garbage point to be treated node, the garbage point to be treated node may be set as a midpoint of the edge, and the feature of the garbage point to be treated node may be set based on the feature of the original edge. For example, the current garbage volume and the garbage increment at the future moment of the feature of the garbage point to be treated node may be set as the current garbage volume of the original edge and the garbage increment at the future moment. In addition, the original edge may be divided into two new edges (e.g., half of the original edge, respectively). The features of the two new edges may also be adjusted accordingly. For example, for the feature of each edge of the two new edges, the current garbage volume and the garbage increment at the future moment may be adjusted to half of the current garbage volume and the garbage increment at the future moment of the original edge accordingly. Other information may be further adjusted accordingly, for example, a length feature value of the edge may be adjusted to be half of the length feature value of the original edge.

It should be noted that the node (e.g., the intersection node) in the garbage treatment map 414 and the garbage point to be treated node, and the edge and the garbage point to be treated node may be converted to each other over time. The management platform 130 may achieve adjustment by setting whether the value of the node or edge is the feature value of the garbage point to be treated node (e.g., 1 or 0).

In some embodiments, after the implement of the garbage dispatching plan is completed (for example, a daily garbage cleaning of the garbage truck is completed), the management platform 130 may generate, according to the at least one garbage point to be treated, the departure point of the garbage truck, and the road network information of the target area, a new garbage treatment map. The management platform 130 may further update the feature of the node (such as the departure point node and the intersection node) and the edge in the garbage treatment map, and generate, based on the updated garbage treatment map, the garbage treatment sub-map corresponding to the target area (see FIG. 5).

In 420, determining, based on the garbage treatment map, the garbage truck dispatching plan of the target area.

In some embodiments, the management platform 130 may determine a garbage truck dispatching plan 420 of the target area based on the garbage treatment map 414. For the relevant description regarding the garbage truck dispatching plan, please refer to FIG. 2 and description thereof.

In some embodiments, the management platform 130 may determine the garbage truck dispatching plan based on a dispatching plan determination model.

The dispatching plan determination model may refer to a model configured to determine the garbage truck dispatching plan. In some embodiments, the dispatching plan determination model may be a trained machine learning model. For example, the dispatching plan determination model may include a recurrent neural networks model, a convolutional neural networks model, other custom model structures, or any combination thereof.

In some embodiments, the dispatching plan determination model may include a trained graph neural network model. The management platform 130 may input the garbage treatment map 414 into the dispatching plan determination model, process the garbage treatment map 414 through the dispatching plan determination model, and output the garbage truck dispatching plan from the departure point node.

In some embodiments, the dispatching plan determination model may be obtained by training a plurality of sample garbage treatment maps with labels. The sample garbage treatment maps may be a plurality of historical garbage treatment maps, and the labels may be determined based on the garbage truck dispatching plans corresponding to the sample garbage treatment maps. For example, the label may include the departure point, the type, the departure time, etc. of the garbage truck corresponding to distribution, a count, and a garbage volume of the garbage point to be treated nodes in the sample garbage treatment map. The label may be labelled manually, etc.

When training the initial dispatching plan determination model, the management platform 130 may input each sample garbage treatment map into the initial dispatching plan determination model, process each sample garbage treatment map through the dispatching plan determination model, and output the garbage truck dispatching plan. The management platform 130 may construct a loss function based on the label of each sample garbage treatment map and the output of the initial dispatching plan determination model, and iteratively update parameters of the dispatching plan determination model based on the loss function until a preset condition is satisfied, complete the training, and obtain a trained dispatching plan determination model. The preset condition may be that the loss function is smaller than a threshold, the loss function converges, or a training period reaches a threshold.

In some embodiments of the present disclosure, the determining the garbage dispatching plan through the garbage treatment map can make the determination of the garbage dispatching plan more rapid and efficient.

FIG. 5 is a flowchart illustrating another exemplary process for determining a garbage truck dispatching plan in a target area according to some embodiments of the present disclosure.

In some embodiments, the process 500 may be executed by the management platform 130. As shown in FIG. 5, the process 500 may include the following operations.

In 510, determining, based on a garbage treatment map 511, at least one garbage treatment sub-map. Each of the at least one garbage treatment sub-map may include at least one departure point node.

The garbage treatment sub-map may refer to a map composed of at least some nodes and/or edges of the garbage treatment map 511.

In some embodiments, the management platform 130 may determine the at least one garbage treatment sub-map of the garbage treatment map 511 based on road network information of a city, a physical planning, or an administrative planning. For example, if a city includes an area A, an area B, an area C, etc., the management platform 130 may correspondingly divide the garbage treatment map 511 into three garbage treatment sub-maps, which may be a garbage treatment sub-map corresponding to the area A, a garbage treatment sub-map corresponding to the area B, and a garbage treatment sub-map corresponding to the area C, respectively.

Each of the at least one garbage treatment sub-maps may include at least one departure point node. The departure point node may be determined according to a preset garbage truck departure point (e.g., a stop point of the garbage truck, a garbage treatment station) in the area of the city corresponding to each garbage treatment sub-map.

In some embodiments, the management platform 130 may divide the garbage treatment map based on a preset sub-map division mode, and determine the at least one garbage treatment sub-map.

In some embodiments, the management platform 130 may perform a plurality of rounds of iterative divisions on the garbage treatment map based on the preset sub-map division mode, and finally determine the at least one garbage treatment sub-map. As shown in FIG. 5, the at least one garbage treatment sub-map finally determined based on the garbage treatment map 511 may be a sub-map 512, a sub-map 513, and a sub-map 514.

Each of the plurality of rounds of iterative divisions performed on the garbage treatment map 511 through the preset sub-map division mode may include the following operations S1 to S5.

In S1, determining, based on the departure point node of the garbage treatment map 511, at least one initial garbage treatment sub-map. Each of the at least one initial garbage treatment sub-map may include a departure point node.

The initial garbage treatment sub-map may refer to a garbage treatment sub-map obtained when the garbage treatment map 511 is divided in each iteration. In some embodiments, the management platform 130 may take each of the at least one garbage truck departure point as a start node or a reference node of the corresponding at least one initial garbage treatment sub-map.

As shown in FIG. 5, the departure point node in the garbage treatment map 511 may include a node n1, a node n9, and a node n12, that is, three initial garbage treatment sub-maps may be determined. Each initial garbage treatment sub-map at least may include the corresponding departure point node, for example, the departure point node n9 included in the initial garbage treatment sub-map 512. It may be understood that a count of the departure point nodes may be used to determine a count of the initial garbage treatment sub-maps. For example, the aforementioned 3 departure point nodes may determine that the count of initial garbage treatment sub-maps is 3.

In S2, taking an intersection node (including an intersection node converted to the garbage point to be treated node) of the garbage treatment map 511 as a node to be distributed, and selecting, based on a preset screening mode, a target node from the node to be distributed.

A node to be distributed may refer to a node of the garbage treatment map that is not divided into the initial garbage treatment sub-map.

The target node may refer to a node selected from the node to be distributed in a current iteration to determine an initial garbage treatment sub-map to which the node belongs.

In some embodiments, the management platform 130 may select at least one node from the node to be distributed as the target node based on a preset strategy, for example, several nodes to be distributed near a certain departure point node (e.g., smaller than a preset distance threshold) may be selected as the target nodes based on a random selection strategy.

In some embodiments, the management platform 130 may select at least one target node from the node to be distributed based on the preset screening mode.

The preset screening mode may be selecting the target node based on a current preferred value of the node to be distributed. The current preferred value may be related to a first distance between the node and the initial garbage treatment sub-map with a smallest current sub-map load value, and a second distance between a previous node target node and the node.

The preferred value may be used to determine a probability value of the node to be distributed being selected as the target node. The preferred value may be a value in an interval of [0, 1], e.g., 0.8. The greater the preferred value of the node to be distributed is, the more preferentially the node to be distributed may be selected. The preferred value may further be in other expressions, e.g., level 1, level 2, level 3, etc. In some embodiments, the management platform 130 may determine the preferred value of each node to be distributed based on the first distance between the node to be distributed and the garbage treatment sub-map with a smallest current sub-map load value, and the second distance between a previous target node and the node.

The sub-map load value may refer to a pressure load of the current initial garbage treatment sub-map, which may be used to represent complexity of the initial garbage treatment sub-map, pressure of the garbage cleaning work of the garbage truck, etc. The sub-map load value may be a numeric value, such as 4, 10. The greater the value is, the greater the sub-map load value of the corresponding initial garbage treatment sub-map is. The sub-map load value may be determined based on a count of nodes and a count of edges of the current initial garbage sub-map. Merely by way of example, the sub-map load value may be equal to a sum of the count of garbage point to be treated nodes and the count of garbage point to be treated edges in an initial garbage treatment sub-map.

In some embodiments, the sub-map load value may include a first load value and a second load value.

The first load value may represent the count of garbage point to be treated nodes in the initial garbage treatment sub-map, which may be a numerical value, e.g., 8. The greater the count of the garbage point to be treated nodes in the initial garbage treatment sub-map is, the greater the first load value is. In some embodiments, the first load value may be equal to the count of garbage point to be treated nodes in the initial garbage treatment sub-map.

The second load value may represent the count of nodes and the count of edges in the initial garbage treatment sub-map, which may be a numerical value, for example, 10. The greater the count of nodes and the count of edges in the initial garbage sub-map is, the greater the second load value is. In some embodiments, the second load value may be equal to the sum of the count of nodes and the count of edges in the initial garbage sub-map.

In some embodiments, the sub-map load value may be determined based on the first load value and the second load value. Exemplarily, the sub-map load value may be determined based on the following equation (2):

P=k₃*P₁+k₄*P₂ (2)

where, P in equation (2) denotes the sub-map load value of the initial garbage treatment sub-map; P₁ denotes the first load value of the initial garbage treatment sub-map; P₂ denotes the second load value of the initial garbage treatment sub-map; k₃ and k₄ are preset weight coefficients, for example, k₃=0.7, and k₄=0.5.

In some embodiments, the first distance may be determined based on a distance between the current node to be distributed and the reference node of the initial garbage treatment sub-map (i.e., the departure point node of the initial garbage treatment sub-map). For example, the first distance may be determined based on a sum of lengths of edges corresponding to a shortest route connecting the current node to be distributed and the reference node.

As shown in FIG. 5, for the sub-map 512, the first distance between the node to be distributed n5 and the reference node n9 of the sub-map 512 may be determined based on a sum of a length of edge G and a length of edge N. A length of edge M may be determined by a length feature value (e.g., 200 m) in the feature of the edge M, and a length of edge F may be determined similarly.

In some embodiments, the second distance may be determined based on a sum of lengths of edges corresponding to a shortest route connecting the current node to be distributed and the previous target node. The previous target node may be a last target node divided into the initial garbage treatment sub-map in the previous round of sub-map division.

In some embodiments, the management platform 130 may further determine the initial garbage treatment sub-map with a smallest sub-map load value based on the sub-map load value of each initial garbage treatment sub-map, and determine, based on the first distance and the second distance of each node to be distributed, the preferred value of each node to be distributed. The smaller the first distance is, the greater the preferred value is; and the greater the second distance is, the greater the preferred value is. In some embodiments, the management platform 130 may determine a first preferred value based on the first distance of the node to be distributed, and determine a second preferred value based on the second distance of the node to be distributed, and further determine a final preferred value of the node to be distributed based on an average value of the first preferred value and the second preferred value of the node to be distributed.

In some embodiments, the management platform 130 may sort the preferred value of each of the nodes to be distributed (e.g., in a descending order), and select a node to be distributed with a largest preferred value as the target node.

In some embodiments of the present disclosure, the preset screening mode may help to balance the load of each initial garbage treatment sub-map, and prevent a size of each initial garbage treatment sub-map from being unbalanced.

In S3, determining, based on a target function value of the target node relative to each of the at least one initial garbage treatment sub-map, the initial garbage treatment sub-map to which the target node belongs.

The target function value may be used to determine a probability value that the target node screened out in the operation S2 is finally divided into a certain initial garbage treatment sub-map of the at least one initial garbage treatment sub-map. The target function value may be related to the sub-map load value of the initial garbage treatment sub-map and a first distance between the target node and the initial garbage treatment sub-map. The smaller the target function value of the target node relative to a certain initial garbage treatment sub-map is, the greater the probability of the target node being divided into the initial garbage treatment sub-map is.

In some embodiments, the target function value may be determined based on the sub-map load value and a proximity value. Exemplarily, the target function may be a preset algorithm or equation. For example, the target function may be equation (3) as shown below:

F=k₅*P+k₆*d (3)

The target function value may be determined based on the equation (3), where F in equation (3) denotes the target function value; P denotes the sub-map load value of the initial garbage treatment sub-map into which the target node is to be divided; k₅ and k₆ are preset weight coefficients, which may be preset values, for example, k₅=0.5, and k₆=0.3; d denotes the proximity value, which may be the first distance between the target node and the initial garbage treatment sub-map into which the target node is to be divided.

In some embodiments, the management platform 130 may determine, based on the equation (3), the target function value when the target node is correspondingly divided into each initial garbage treatment sub-map, and assign the target node to the initial garbage treatment sub-map corresponding to the smallest target function value F.

In some embodiments, the target function value may also be related to a similarity between the garbage increment of the garbage point to be treated in the initial garbage treatment sub-map at the future moment and the garbage increment of the target node at the future moment.

The similarity of the garbage increment may be used to represent a degree of similarity between the garbage increment of the target node and the garbage increment of the garbage point to be treated in the initial garbage treatment sub-map. The similarity of the garbage increment may be a value in an interval of [0, 1]. The greater the value is, the greater the similarity is.

In some embodiments, the management platform 130 may obtain the garbage increment of each garbage point to be treated in each initial garbage treatment sub-map at the future moment (e.g., one hour in the future), determine an average value of the garbage increment of all the garbage points to be treated in each initial garbage treatment sub-map, determine, based on a difference between the average value and the garbage treatment of the node to be distributed at the future moment (e.g., one hour in the future), the similarity of the garbage increment. The smaller the difference value is, the greater the similarity of the garbage increment is.

In some embodiments, the management platform 130 may introduce a calculation item of the similarity of the garbage increment on the basis of the above equation (3) to determine the target function value. Exemplarily, the target function value may be determined based on the following equation (4):

F=k₅*P+k₆*d+k₇*(1/S) (4)

where F in equation (4) denotes the target function value; S denotes the similarity between the garbage increment of the target node at the future moment and the garbage increment of the garbage point to be treated in the initial garbage treatment sub-map at the future moment into which the target node is to be divided; k₇ is a preset weight coefficient, which may be a preset value, for example, k₇=0.2, and k₅, P, k₆, and d in equation (4) are the same as the corresponding calculation items in the equation (3), which will not be repeated here.

In some embodiments of the present disclosure, when determining the initial garbage treatment sub-map to which the target node belongs, the sub-map load value and the proximity value may be introduced, which may make the load of the plurality of divided garbage sub-maps to be treated more balanced. In addition, the introduction of the similarity of the garbage increment may help to divide the nodes with similar garbage increments into one garbage treatment sub-map, thereby facilitating a unified dispatching of the subsequent garbage trucks.

In S4, determining a new target node, and repeating the above operations until the initial garbage treatment sub-maps to which all the nodes to be distributed belong are determined.

The new target node may refer to the node to be distributed selected by the current iterative sub-map division after a previous round of sub-map division is completed. For the screening of the new target node, please refer to the mode of the operation S2.

In some embodiments, the management platform 130 may repeat the operations of S2 and S3 of each iteration, and gradually divide undistributed nodes and edges in the garbage treatment map 511 into the target initial garbage treatment sub-map until all the nodes to be distributed in the garbage treatment map 511 are distributed to the initial garbage treatment sub-map to which all the nodes to be distributed belong, and the iteration may end.

It should be noted that, when two nodes to be distributed (e.g., nodes n5 and n2 in FIG. 5) connected by a certain edge of the garbage treatment map 511 (e.g., edge D in FIG. 5) are respectively distributed to two different garbage treatment sub-maps (e.g., sub-map 512 and sub-map 513 of FIG. 5), the management platform 130 may divide the edge into two segments (e.g., n5-Pₘ and Pₘ-n2) based on an midpoint of the edge (e.g., the midpoint Pm), and divide the two segments into the two garbage treatment sub-maps (e.g., the sub-map 512 and the sub-map 513 in FIG. 5) respectively. In this case, if the edge is a garbage point to be treated, garbage treatment work of the garbage point to be treated may respectively belong to the garbage treatment sub-maps to which the two segments of the edge belong (as shown in the sub-map 512 and the sub-map 513 of FIG. 5). Accordingly, the garbage cleaning work of the streets corresponding to the two segments of the edge may be handled by the garbage truck in the sub-area corresponding to the sub-image 512 and the garbage truck in the sub-area corresponding to the sub-image 513 respectively.

In S5, taking each of the initial garbage treatment sub-maps after the operations as a final garbage treatment sub-map.

As shown in FIG. 5, when the iteration ends, all the nodes and edges in the garbage treatment map 511 may be divided, and then the nodes and edges contained in the final three garbage treatment sub-maps may be determined, such as the garbage treatment sub-map 512, the garbage treatment sub-map 513 and the garbage treatment sub-map 514.

It should be noted that the preset sub-map division mode may include a division mode such as dividing by node, dividing by edge, etc. The above preset sub-map division mode of dividing by node is merely used as an example, and is not intended to limit herein.

In some embodiments of the present disclosure, performing an automatic map division on the garbage treatment map through a preset sub-map division mode may improve efficiency of dividing the garbage treatment sub-maps, and at the same time, the load of the sub-maps when the garbage treatment sub-maps are divided may be taken into consideration, which can help to make the divided garbage treatment sub-maps more balanced, and help to make the further determined garbage cleaning work load more balanced.

In 520, determining, based on the garbage treatment sub-map, a garbage truck dispatching plan of the departure point of the garbage truck corresponding to departure point node in the garbage treatment sub-map, and determining a garbage truck dispatching plan corresponding to the garbage treatment sub-map.

The garbage truck dispatching plan of the departure point of the garbage truck may refer to a garbage truck dispatching plan for cleaning up garbage from the departure point of the garbage truck. As shown in FIG. 5, for the garbage treatment sub-map 512, the garbage truck dispatching plan may include a garbage truck dispatching plan starting from the departure point node n9. The garbage truck dispatching plan may include a type, a capacity, a departure time, etc. of the garbage truck of the departure point of the garbage truck corresponding to the departure point node n9.

In some embodiments, the management platform 130 may determine, based on information such as a count of the departure points of the garbage truck, a count of garbage points to be treated, a current garbage volume of each garbage point to be treated, a distance between the plurality of garbage points to be treated, the garbage truck dispatching plan corresponding to each garbage treatment sub-map.

In some embodiments, the garbage truck dispatching plan may further include a garbage truck route. The management platform 130 may determine a route starting from the departure point node of the garbage treatment sub-map and traversing the garbage point to be treated in the garbage treatment sub-map in an area corresponding to the garbage treatment sub-map as the garbage truck route; and determine, based on the garbage truck route, a garbage truck dispatching plan corresponding to the garbage treatment sub-map.

The garbage truck route may refer to a driving route of the garbage truck from the departure point to at least one garbage point to be treated. The garbage truck route may be a sequence of nodes and edges in a certain garbage treatment sub-map. As shown in FIG. 5, for the garbage treatment sub-map 512, the garbage truck route may be n9-n10-n8-n7-n5, etc.

The garbage truck route may be determined based on a preset rule. For example, the garbage truck route may be determined according to a preset garbage truck driving route in the area corresponding to the garbage treatment sub-map. In some embodiments, the management platform 130 may determine a shortest route of all the garbage points to be treated in the area corresponding to the garbage treatment sub-map as the garbage truck route.

In some embodiments, the management platform 130 may take a departure point node of the garbage treatment sub-map as a starting point, and perform a plurality of rounds of traversal operations from the starting point based on the area corresponding to the garbage treatment sub-map. Each traversal operation may include: obtaining all the garbage point to be treated nodes in the garbage treatment sub-map, and determining a next garbage node to be treated based on a current garbage volume, a garbage increment at a plurality of future moments of each of all the garbage point to be treated nodes, a distance between each of all the garbage point to be treated nodes and a current node, etc. After the current round of traversal operations ends, the management platform 130 may perform a next round of traversal operations based on the next garbage point to be treated node as a new starting point until a sequence of all the garbage points to be treated is determined, and the garbage truck route may be obtained.

In some embodiments, the intersection node of the garbage treatment sub-map may have a treatment priority value. The garbage truck route may be determined based on the treatment priority value of each intersection node. The treatment priority value of the intersection node may be determined based on a peak value of a route from the current node to the intersection node.

The treatment priority value of the intersection node may be used to represent a priority value that the garbage truck may go to the intersection corresponding to the intersection node. The treatment priority value may be a value in a range of [0, 1], such as 0.3 and 0.8. The greater the treatment priority value of the intersection node is, the more priority the garbage truck goes to the intersection corresponding to the intersection node is.

In some embodiments, the treatment priority value of the intersection node may be preset. For example, the management platform 130 may preset the treatment priority value based on information such as a location (e.g., a downtown area, a suburb area), traffic information (e.g., a busy section, a length, a width) of each intersection node of the target area corresponding to each garbage treatment sub-map, a distance between each intersection node of the target area corresponding to each garbage treatment sub-map and the departure point of the garbage truck, etc.

The peak value of the route of the intersection node may be used to represent traffic flow of the route, whether there is traffic congestion, a duration of the congestion, etc. The peak value may be determined based on historical traffic data of the route in different periods of time. For example, the management platform 130 may count the traffic flow (e.g., the traffic flow, a pedestrian volume) in different periods of time (e.g., morning, noon, afternoon, etc.) of each day in a past period of time (e.g., half a year, one month), and determine the peak value based on the traffic flow. It should be noted that the peak value may include a plurality of different values, for example, the peak value may include a value of 0.8 during 8:00-9:00 in the morning and a value of 0.3 during 12:00-13:00.

In some embodiments, the management platform 130 may determine the treatment priority value of the corresponding intersection node based on the peak value of each intersection. The greater the peak value of the route is, the smaller the treatment priority value of the intersection node is.

In some embodiments, after determining the treatment priority value of each intersection node in the garbage treatment sub-map, the management platform 130 may determine the garbage truck route based on the treatment priority value of each intersection node. For example, the management platform 130 may sort the treatment priority values of all the intersection nodes in the garbage treatment sub-map in a descending order, and determine the garbage truck route using the corresponding order of the intersection nodes as an order of the intersections to which the garbage truck goes according to the order of the treatment priority value from high to low.

In some embodiments of the present disclosure, the treatment priority value of the intersection node may be determined by the peak value of the route, and the traffic congestion condition may be introduced, which can more effectively avoid the traffic congestion condition when the garbage truck route is determined later, so as to better carry out a garbage truck route planning.

In some embodiments, the peak value of the route may be relevant to a pedestrian volume sequence.

It may be understood that the greater the pedestrian volume in the route is, the greater the probability of traffic congestion is. In addition, in the route, the pedestrian volume in different periods of time may be different. Accordingly, the probabilities of traffic congestion at different periods of time may be also different. In some embodiments, the management platform 130 may determine the peak value of the route based on a peak value prediction model.

In some embodiments, the peak value prediction model may be a trained machine learning model. For example, the prediction model may include a deep neural networks model, a recurrent neural networks model, a long short-term memory neural networks model, other custom model structures, or the like, or any combination thereof.

In some embodiments, an input of the peak value prediction model may include the pedestrian volume sequences at a plurality of historical moments up to the current moment and one or more future moments. The peak value prediction model may output the peak values of the route at the plurality of future moments by processing the pedestrian volume sequence and the plurality of future moments. For the pedestrian volume sequence at the historical moments, please refer to FIG. 3 and related description thereof.

In some embodiments, the peak value prediction model may be obtained by training a plurality of sample historical pedestrian volume sequences with labels and one or more sample future moments. The sample historical pedestrian volume sequence may be the historical pedestrian volume sequence of a past day or the past week. For example, the pedestrian volume sequence constructed by the pedestrian volume at 0:00, 2:00, 4:00 . . . 16:00 of the past day may be taken as the sample pedestrian volume sequence. Accordingly, 18:00, 20:00, 22:00 of the past day may be taken as the one or more sample future moments. The label may be a peak value corresponding to the one or more sample future moments (for example, 18:00, 20:00, 22:00 of the past day). The peak value may be a value in a range of [0, 1] determined based on the congestion condition of the route. For example, when the route is congested, the label may be 1, and when the route is not congested, the label may be 0. The label may further be determined based on a duration of the congestion. For example, when the route is not congested, the label may be 0; when the duration of the congestion is more than 10 minutes, the label may be 1, and the label may decrease according to a preset ratio (for example, the label may decrease by 0.1 if the congestion duration decreases by every 1 minute). If the congestion time is 5 minutes, the label may be 0.5, etc. The label may be labelled manually, etc.

When training the initial peak value prediction model, the management platform 130 may input each sample historical pedestrian volume sequence and the plurality of sample future moments into the initial peak value prediction model, process each sample historical pedestrian volume sequence and the plurality of sample future moments through the peak value prediction model, and output the peak values at the plurality of sample future moments. The management platform 130 may construct a loss function based on the label of each sample historical traffic sequence and the output of the initial peak value prediction model, and iteratively update parameters of the initial peak value prediction model based on the loss function until a preset condition is satisfied, complete the training is, and obtain a trained peak value prediction model. The preset condition may be that the loss function is smaller than a threshold, the loss function converges, or a training period reaches a threshold.

In some embodiments of the present disclosure, through the peak value prediction model, the high peak value of the route may be obtained more quickly and efficiently by predicting the peak value of the route based on the pedestrian volume sequence.

In some embodiments, in the garbage truck dispatching plan of each garbage treatment sub-map, a departure time of the garbage truck may be related to the garbage truck route.

In the garbage truck dispatching plan of each garbage treatment sub-map, the departure time of the garbage truck may be determined according to a total length of the garbage truck route, the traffic flow of each road section, and the congestion condition, etc. For example, the greater the total length of the garbage truck route is, the earlier the departure time of the garbage truck may be.

In some embodiments, the management platform 130 may determine, based on the current garbage volume and the garbage increment of the garbage point to be treated in the garbage truck route, the departure time of the garbage truck in the garbage truck dispatching plan. Exemplarily, the management platform 130 may obtain the current garbage volume of each garbage point to be treated in the garbage truck route and the garbage increment at one or more future moments. The greater a sum of the current garbage volume of all the current garbage points to be treated is, the earlier the departure time of the garbage truck may be. In addition, the greater a sum of the garbage increment at one or more future moments of all the current garbage points to be treated is, the earlier the departure time of the garbage truck may be.

In some embodiments of the present disclosure, the departure time of the garbage truck may be determined based on the current garbage volume and the garbage increment of each garbage point to be treated in the garbage truck route which can make the departure time more targeted.

In 530, determining, based on the garbage truck dispatching plan corresponding to each of the at least one garbage treatment sub-map, the garbage truck dispatching plan of the target area.

In some embodiments, the management platform 130 may determine, based on the garbage truck dispatching plan corresponding to each garbage treatment sub-map, a garbage dispatching plan of the sub-area of the target area corresponding to each garbage treatment sub-map, and further generate the garbage truck dispatching plan of the target area. The garbage truck dispatching plan of the target area may include the departure time of the garbage truck, the type of the garbage truck, the count of the garbage trucks, the garbage truck route, etc. of the garbage truck dispatching plan of each sub-area. In some embodiments, the management platform 130 may further distribute the garbage truck based on a garbage treatment progress, a garbage treatment duration, etc. of the garbage truck dispatching plan of each sub-area, and then determine the garbage truck dispatching plan of the target area, which is not limited in the present disclosure.

In some embodiments of the present disclosure, the garbage treatment map may be by divided and the garbage truck dispatching plan of the target area corresponding to the divided garbage treatment sub-map may be determined, which can be helpful to arrange the garbage truck dispatching plan in the target area in a more detailed way, and reduce workload of garbage cleaning, thereby making the garbage truck dispatching plan more reasonable and effective, and saving management costs.

It should be noted that the above description regarding the processes 200, 300, 400 and 500 are merely for example and illustration, and not intended to limit the scope of the present disclosure. For those skilled in the art, various modifications and changes can be made to the processes under the guidance of the present disclosure. However, these modifications and changes are still within the scope of the present disclosure.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements and amendments to the present disclosure. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various parts of this specification are not necessarily all referring to the same embodiment. In addition, some features, structures, or features in the present disclosure of one or more embodiments may be appropriately combined.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for managing a garbage treatment device in a smart city, executed based on a management platform of an Internet of Things (IoT) system for managing the garbage treatment device in the smart city, comprising:
obtaining a garbage accumulation condition in a target area;
determining, based on the garbage accumulation condition, at least one sub-area in the target area as at least one garbage point to be treated; and
determining, based on the at least one garbage point to be treated, a garbage truck dispatching plan of the target area, wherein the garbage truck dispatching plan includes: a type of at least one garbage truck to be dispatched, and a departure time of the at least one garbage truck.

2. The method of claim 1, wherein the garbage accumulation condition includes a historical garbage volume of each sub-area in the target area at a plurality of historical moments; and
the determining, based on the garbage accumulation condition, at least one sub-area in the target area as at least one garbage point to be treated comprises:
predicting, based on the historical garbage volume of each sub-area in the target area at the plurality of historical moments, a garbage increment of each sub-area at a future moment; and
determining, based on the historical garbage volume and the garbage increment of each sub-area, the at least one garbage point to be treated.

3. The method of claim 2, wherein the predicting, based on the historical garbage volume of each sub-area in the target area at the plurality of historical moments, a garbage increment of each sub-area at a future moment comprises:
predicting, based on the historical garbage volume of each sub-area in the target area at the plurality of historical moments and a historical pedestrian volume sequence, the garbage increment of each sub-area at the future moment, wherein the historical pedestrian volume sequence is determined based on pedestrian volume corresponding to the sub-area at the plurality of historical moments.

4. The method of claim 2, wherein the determining, based on the historical garbage volume and the garbage increment of each sub-area, the at least one garbage point to be treated comprises:
determining, based on the historical garbage volume and the garbage increment of each of sub-area, a treatment demand degree of each of sub-area; and
determining, based on the treatment demand degree of each of sub-area, the at least one garbage point to be treated.

5. The method of claim 1, wherein the determining, based on the at least one garbage point to be treated, a garbage truck dispatching plan of the target area comprises:
constructing, based on the at least one garbage point to be treated, a departure point of the garbage truck, and road network information of the target area, a garbage treatment map corresponding to the target area, wherein
a node of the garbage treatment map includes a departure point node and an intersection node, the departure point node corresponding to the departure point of the garbage truck, and the intersection node corresponding to a street intersection in the target area;
a node feature of the node of the garbage treatment map includes: whether the node is a garbage point to be treated, a historical garbage volume, and a garbage increment at a future moment;
an edge of the garbage treatment map corresponds to a street in the target area;
an edge feature of the edge of the garbage treatment map includes: whether the edge is a garbage point to be treated, the historical garbage volume, and the garbage increment at a future moment; and
determining, based on the garbage treatment map, the garbage truck dispatching plan of the target area.

6. The method of claim 5, wherein the determining, based on the garbage treatment map, the garbage truck dispatching plan of the target area comprises:
determining at least one garbage treatment sub-map based on the garbage treatment map, wherein each of the at least one garbage treatment sub-map includes the at least one departure point node;
determining, based on the garbage treatment sub-map, a garbage truck dispatching plan of the departure point of the garbage truck corresponding to the departure point node in the garbage treatment sub-map, and determining a garbage truck dispatching plan corresponding to the garbage treatment sub-map; and
determining, based on the garbage truck dispatching plan corresponding to each of the at least one garbage treatment sub-map, the garbage truck dispatching plan of the target area.

7. The method of claim 6, wherein the determining at least one garbage treatment sub-map based on the garbage treatment map comprises:
determining, based on the departure point node of the garbage treatment map, at least one initial garbage treatment sub-map, wherein each of the at least one initial garbage treatment sub-map includes the at least one departure point node;
taking the intersection node of the garbage treatment map as a node to be distributed, and selecting, based on a preset screening mode, a target node from the node to be distributed;
determining, based on a target function value of the target node relative to each of the at least one initial garbage treatment sub-map, the initial garbage treatment sub-map to which the target node belongs;
determining a new target node, and repeating the operations until the initial garbage treatment sub-maps to which all the nodes to be distributed belong are determined; and
taking each of the initial garbage treatment sub-maps after the operations as a final garbage treatment sub-map.

8. The method of claim 6, wherein the garbage truck dispatching plan further includes a garbage truck route; and
the determining a garbage truck dispatching plan corresponding to the garbage treatment sub-map comprises:
determining a route starting from the departure point node of the garbage treatment sub-map and traversing the garbage point to be treated in the garbage treatment sub-map in an area corresponding to the garbage treatment sub-map as the garbage truck route; and
determining, based on the garbage truck route, the garbage truck dispatching plan corresponding to the garbage treatment sub-map.

9. The method of claim 1, further comprising:
feeding back the garbage truck dispatching plan of the target area to a user.

10. The method of claim 9, wherein the IoT system for managing the garbage treatment device in the smart city further includes a user platform, a service platform, a sensor network platform, and an object platform, wherein
the object platform is configured to obtain the garbage accumulation condition;
the sensor network platform is configured to transmit the garbage accumulation condition to the management platform;
the sensor network platform includes several sensor network sub-platforms;
the management platform includes a general database of the management platform and several management sub-platforms;
the service platform is configured to feed back the garbage truck dispatching plan to the user through the user platform;
the service platform includes several service sub-platforms;
each of the several sensor network sub-platforms, each of the several management sub-platforms, and each of the several service sub-platforms are corresponding to the target area; and
the general database of the management platform communicates with the several sensor network sub-platforms corresponding to the several management sub-platforms through the several management sub-platforms.

11. An Internet of Things (IoT) system for managing a garbage treatment device in a smart city comprising a user platform, a service platform, a management platform, a sensor network platform, and an object platform, wherein
the object platform is configured to obtain a garbage accumulation condition in a target area;
the sensor network platform is configured to transmit the garbage accumulation condition in the target area obtained by the object platform to the management platform; and
the management platform is configured to:
determine, based on the garbage accumulation condition, at least one sub-area in the target area as at least one garbage point to be treated; and
determine, based on the at least one garbage point to be treated, a garbage truck dispatching plan of the target area, wherein the garbage truck dispatching plan includes: a type of at least one garbage truck to be dispatched, and a departure time of the at least one garbage truck; and
the service platform is configured to feed back the garbage truck dispatching plan to a user through the user platform.

12. The system of claim 11, wherein
the sensor network platform includes several sensor network sub-platforms;
the management platform includes a general database of the management platform and several management sub-platforms;
the service platform includes several service sub-platforms;
each of the several sensor network sub-platforms, each of the several management sub-platforms, and each of the several service sub-platforms are corresponding to the target area; and
the general database of the management platform communicates with the several sensor network sub-platforms corresponding to the several management sub-platforms through the several management sub-platforms.

13. The system of claim 11, wherein the garbage accumulation condition includes a historical garbage volume of each sub-area in the target area at a plurality of historical moments; and
the management platform is further configured to:
predict, based on the historical garbage volume of each sub-area in the target area at the plurality of historical moments, a garbage increment of each of sub-area at a future moment; and
determine, based on the historical garbage volume and the garbage increment of each of sub-area, the at least one garbage point to be treated.

14. The system of claim 13, wherein the management platform is further configured to:
predict, based on the historical garbage volume of each sub-area in the target area at the plurality of historical moments and a historical pedestrian volume sequence, the garbage increment of each of sub-area at the future moment, wherein the historical pedestrian volume sequence is determined based on pedestrian volume corresponding to the sub-area at the plurality of historical moments.

15. The system of claim 13, wherein the management platform is further configured to:
determine, based on the historical garbage volume and the garbage increment of each of sub-area, a treatment demand degree of each of sub-area; and
determine, based on the treatment demand degree of each of sub-area, the at least one garbage point to be treated.

16. The system of claim 11, wherein the management platform is further configured to:
construct, based on the at least one garbage point to be treated, a departure point of the garbage truck, and road network information of the target area, a garbage treatment map corresponding to the target area, wherein
a node of the garbage treatment map includes a departure point node and an intersection node, the departure point node corresponding to the departure point of the garbage truck, and the intersection node corresponding to a street intersection in the target area;
a node feature of the node of the garbage treatment map includes: whether the node is a garbage point to be treated, a historical garbage volume, and a garbage increment at a future moment;
an edge of the garbage treatment map corresponds to a street in the target area;
an edge feature of the edge of the garbage treatment map includes: whether the edge is a garbage point to be treated, the historical garbage volume, and the garbage increment at a future moment; and
determine, based on the garbage treatment map, the garbage truck dispatching plan of the target area.

17. The system of claim 16, wherein the management platform is further configured to:
determine at least one garbage treatment sub-map based on the garbage treatment map, wherein each of the at least one garbage treatment sub-maps includes the at least one departure point node;
determine, based on the garbage treatment sub-map, a garbage truck dispatching plan of the departure point of the garbage truck corresponding to the departure point node in the garbage treatment sub-map, and determine a garbage truck dispatching plan corresponding to the garbage treatment sub-map; and
determine, based on the garbage truck dispatching plan corresponding to each of the at least one garbage treatment sub-map, the garbage truck dispatching plan of the target area.

18. The system of claim 17, wherein the management platform is further configured to:
determine, based on the departure point node of the garbage treatment map, at least one initial garbage treatment sub-map, wherein each of the at least one initial garbage treatment sub-maps includes the at least one departure point node;
take the intersection node of the garbage treatment map as a node to be distributed, and select, based on a preset screening mode, a target node from the node to be distributed;
determine, based on a target function value of the target node relative to each of the at least one initial garbage treatment sub-map, the initial garbage treatment sub-map to which the target node belongs;
determine a new target node, and repeating the above operations until the initial garbage treatment sub-maps to which all the nodes to be distributed belong are determined; and
take each of the initial garbage treatment sub-maps after the operations as a final garbage treatment sub-map.

19. The system of claim 17, wherein the dispatching plan further includes: a garbage truck route; and
the management platform is further configured to:
determine a route starting from the departure point node of the garbage treatment sub-map and traversing the garbage point to be treated in the garbage treatment sub-map in an area corresponding to the garbage treatment sub-map as the garbage truck route; and
determine, based on the garbage truck route, the garbage truck dispatching plan corresponding to the garbage treatment sub-map.

20. A non-transitory computer-readable storage medium storing computer instructions, wherein when reading the computer instructions in the storage medium, a computer implements the method for managing a garbage treatment device in a smart city according to claim 1.
